(19) United States
(12) Patent Application Publication
(10) Pub. No.: US 2008/0071003 A1
(43) Pub. Date: Mar. 20, 2008

(54) Method for Producing Molecularly Imprinted Polymers

(75) Inventors: Borje Sellergren, Schwerte (DE); Magdalena M. Titirici, Berlin (DE)

Correspondence Address: YOUNG & THOMPSON, 745 SOUTH 23RD STREET, 2ND FLOOR, ARLINGTON, VA, 22202, US

(73) Assignee: UNIVERSITY OF DORTMUND INFU, Dortmund (DE)

(21) Appl. No.: 11/630,435

(22) PCT Filed: Jul. 4, 2005
(86) PCT No.: PCT/SE05/01096

§ 371 Date: Dec. 22, 2006

(30) Foreign Application Priority Data
Jul. 3, 2004 (DE) 102004032430.1

(51) Int. Cl. C08F 2/46

(52) U.S. Cl. 522/57

(57) ABSTRACT

The invention relates to a method for producing molecular imprinted polymers (MIP) which are applied as a thin film to the surface of a support material, in which a suspension of at least one functional monomer, one template and one initiator is used for the polymerisation, and with which RAFT agents are employed.

The invention relates to a method for producing molecularly imprinted polymers which are applied as a thin polymer film to the surface of a support material, in which at least one monomer, one template and one initiator is used for the polymerisation.

In the fields of medicine, chemistry, pharmaceuticals, food technology and biotechnology, in diagnostics, in drug development, in environmental control, in food control, in doping control and much more, efficient separation and purification methods are required for substance-specific materials. Biomolecules involved here are inter alia enzymes, amino acid derivatives, peptides, nucleotides, monoclonal antibodies, ions, antigens, amino acids, proteins, DNA bases, carbohydrates, drugs, pesticides, nucleic acids, viruses, bacteria or cells.

As regards the separation and purification, different separation processes are combined with one another, as a function of the particular separation problem, in order to optimise the separation. Conventionally chromatographic methods such as HPLC, gel permeation chromatography, ion exchange chromatography or affinity chromatography are used. The disadvantages are low separation factors, limited stability (affinity chromatography) and low binding potential (capacity) of the activated binding sites on the original chromatography support.

So-called molecular imprinted polymers (MIPs) are now being used. They can be programmed for the recognition of small molecules in complex biological specimens. The lock-and-key principle from biological processes is used as a model here. (see: B. Sellergren, The non-covalent approach to molecular imprinting, in Molecularly Imprinted Polymers: Man made mimics ofantibodies and their application in analytical chemistry. (Ed. B. Sellergren.) Techniques and instrumentation in analytical chemistry, Elsevier Science, Amsterdam, Netherlands, 2001, p. 113.)

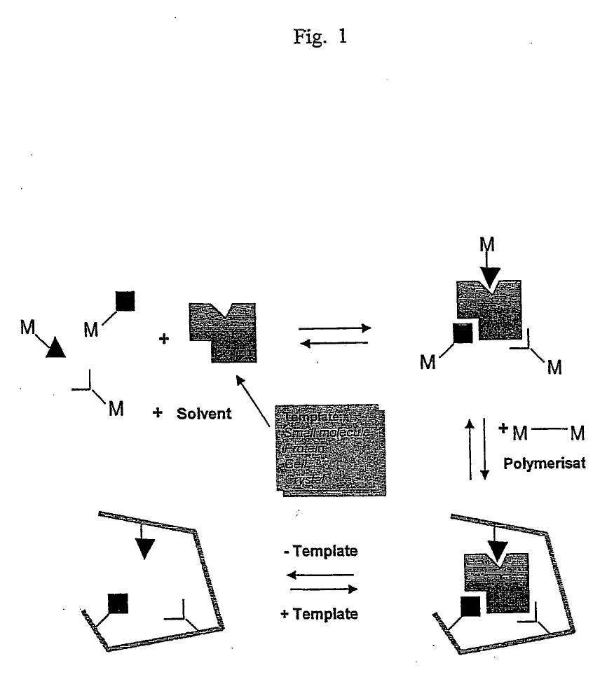

Conventionally MIPs of this kind are produced from a solution of the target molecule (template) and a 3D-crosslinkable polymerizable monomer (functional monomers). A highly crosslinked polymer is thereby formed around the template. After the polymerisation the template is dissolved out. The polymer is thus a porous material with specific spatial arrangement of its functional groups, which possesses cavities with shapes and functionalities complementing the template. Accordingly it has a very high affinity for the template. The principle of MIP production is shown in FIG. 1.

Conventionally MIPs are produced by means of the copolymerisation of commercially available monomers, such as methacrylic acid (MAA), 2- or 4-vinyl-pyridine (VPY), N,N-diethylaminoethyl methacrylate (DEAEMA) and methacrylamide (MAAM), with crosslink monomers such as ethylene glycol dimethacrylate (EDMA), divinylbenzene (DVB), trimethylolpropane tri-methacrylate (TRIM), pentaerythritol triacrylate (PETRA) and methylene-bisacrylamide (MBA), such polymerisation occurring in the presence of a template. Small molecules, macromolecules, cells, viruses, microorganisms or crystals can be used as templates.

Typical production conditions for an optimum binding of the templates often lead to undesirable properties in the polymer morphology, such as irregular polydisperse particles, or wide pore size distributions. In order to obtain imprinted polymer materials with controlled morphology, various polymerisation methods are used according to the prior art, such as suspension or emulsion polymerisation, dispersion polymerisation or precipitation polymerisation. A disadvantage of said methods is the great sensitivity to small variations in terms of the synthesis conditions. Even with a minor modification of the templates the production conditions have to be completely changed. In addition to this, only a restricted number of monomers and solvents can be used. Furthermore, most of the aforementioned procedures are limited to the use of templates of low molecular weights. This precludes in most cases the recognition of macromolecules. The imprinted binding sites are also often hindered sterically and do not exhibit optimum selectivity.

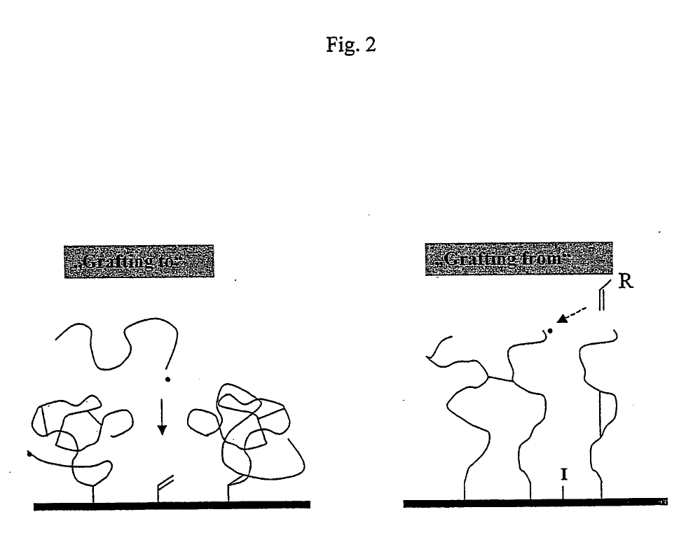

One possible way of solving this problem is the formation of a polymer film on the surface of a support material, for example on silica gel or on organic support materials. A distinction is drawn in the production of the MIP polymer films between the “grafting to” and the “grafting from” method. The production is based on the one hand on the reaction of groups bonded to the surface of the support material with the polymer chains produced, and on the other of immobilised initiators bonded to the surface of the support materials. The methods are shown in FIG. 2.

PCT/SE/00/01776 discloses the production of molecular imprinted polymer films by means of radical polymerisation using immobilised azo initiators. The method shows an improvement of the imprinted polymer in terms of the production process, the molecular recognition and the kinetic properties.

The production nevertheless has other disadvantages. Decomposition of the immobilized initiator leads to the formation of one immobile and one mobile radical both capable of initiating polymerization. Polymerization in solution leads to premature gelation i.e. i.e. if the solution agglomerates, the process comes to a standstill. In addition, it proves to be extremely difficult to control and produce a precise film thickness, which is of particular importance in the separation of inter alia enantiomers. Because of these disadvantages, the industrial use of said method according to PCT/SE/00/01776 is rendered more difficult.

In order to control the radical polymerisation, i.e. to counteract the agglomeration, the use of immobilised iniferters (e.g. benzyl-N,N-diethyl-dithiocarbamate) has been proposed in the prior art. However, said polymer materials show a lower separation efficiency due to grafting inhomogeneities. In addition, said method permits only a photolytic initiation.

The problem is addressed by the invention by providing a method with which the radical polymerisation is controlled and agglomeration prevented and with which homogeneous MIP composite materials with a particular film thickness can be produced.

As a solution, the invention proposes a method of the kind mentioned in the preamble in which RAFT agents are used.

It is possible to control the radical polymerisation by means of Reversible Addition Fragmentation Chain Transfer (RAFT). The RAFT technique for producing structured polymers is known from the prior art. (M. Baum, W. J. Brittain, Macromolecules 2002, 35, 610-615 and U.S. Pat. No. 6,858,309).

Thus we have here investigated means to control the azoinitiated grafting through the addition of chain transfer agents. The use of dithioesters of the general structure:

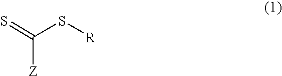

has proven particularly versatile in this regard. These can be structurally tuned to allow polymerization through the so called RAFT-mechanism (reversible addition-fragmentation chain transfer). This features a fast capping of the majority of propagating chains by the RAFT agent (2) followed by the establishment of a dynamic equilibrium between growing and dormant chains according to (3):

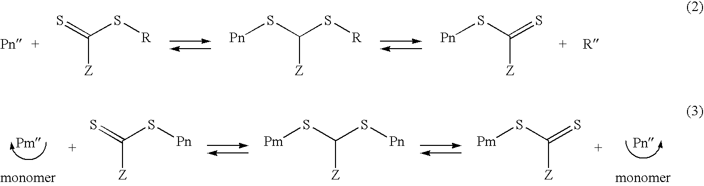

where Pm and Pn are propagating chains and z is an electron withdrawing substituent.

This results in a low radical concentration near the surface, hence less termination by radical recombination, slower kinetics and linear time-conversion curves. Furthermore interchain equilibration reduces chain length dispersity and heterogeneity of the grafts. The focus of this work is the synthesis of MIP composites using the “grafting from” method by controlled radical polymerization via RAFT. The materials can be prepared in short time and exhibit superior mass transfer properties compared to the traditional imprinted bulk monoliths or materials prepared without the polymerization control through RAFT agents.

It was found, surprisingly, that the RAFT technique is particularly well suited to the production of MIP films or MIP composite materials. Agglomeration, therefore, can in particular be prevented to a very large extent by said control. Troublesome agglomerates do not have to be removed by a plurality of purification steps. The yield is therefore increased.

Various immobilised initiators can be used with the method according to the invention, so that it is particularly well suited to the production of MIPs on an industrial scale. Preferably azo-based initiators, iniferters such as benzyl-N,N-diethyl-ditiocarbamate are used. Such initiators can alternatively also be added in solution or else be immobilised and used additionally in solution. By iniferter we understand any substance that can act as an initiator of polymerisation, as a chain transfer agent and/or as a terminator of polymerisation.

Surprisingly, uniform, homogeneous polymer films can be produced with the method according to the invention. A small thickness of the polymer film permits a high accessibility of the imprinted binding sites and hence favourable exchange kinetics. The latter is of particular importance for the separation of racemates. It was found that the best result is achieved with an average thickness of the film of 1 to 5 nm. Thin MIP films can be produced in this way.

The MIPs produced by the method according to the invention exhibit high accessibility, high selectivity, better kinetics, higher separation factors and high homogeneity.

The expressions MIPs, MIP composite materials and imprinted polymer films are used as synonyms here.

Particularly preferably the RAFT agent according to the invention has the general structure shown in (1): 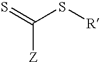
where R represents a homolytic leaving group and Z is typically an electronwithdrawing group which allows the thiocarbonyl group to react with radicals. Preferably R is a phenyl group and Z is a cumyl group, such as (2-phenyl)-isopropyl.

In reversible-addition-fragmentation transfer (RAFT) polymerizations, the control agent is typically a dithioester or related compound. RAFT s useful with the present invention include, for example, 1-phenycontrol agentlprop-2-yl phenyldithioacetate; 1-phenylethyl phenyldithioacetate, cumyl phenylditioacetate, 2-phenylprop-2-yl dithiobenzoate; 1-phenylprop-2-yl p-bromodithiobenzoate; 1-phenylethyl dithiobenzoate; 2-cyanoprop-2-yl dithiobenzoate; 4-cyanopentanoic acid dithiobenzoate; 1-acetoxyethyl dithiobenzoate; hexakis(thiobenzoylthiomethyl)benzene; 1,4-bis(thiobenzoylthiomethyl)benzene; 1,2,4,5-tetrakis(thiobenzoylthiomethyl)benzene; ethoxycarbonylmethyl dithioacetate; 2-(ethoxycarbonyl)prop-2-yl dithiobenzoate; tert-butyl dithiobenzoate; 1,4-bis(2-thiobenzoylthioprop-2-yl)benzene; 4-cyano-4-(thiobenzoylthio)pentanoic acid; dibenzyl trithiocarbonate; carboxymethyl dithiobenzoate; s-benzyl diethoxyphosphinyldothioformate; 2,4,4-trimethylpent-2-yl dithiobenzoate; 2-(ethoxycarbonyl)prop-2-yl dithiobenzoate; 2-phenylprop-2-yl 1-dithionaphthalate; 2-phenylprop-2-yl 4-chlorodithiobenzoate.

It has been further demonstrated that the initiation is possible both with the aid of UV rays and at elevated temperature.

Preferably the support material consists of porous or non-porous, planar or non-planar, inorganic or organic material. Examples of inorganic supports are solid supports such as oxides including SiO₂, TiO₂, ZrO₂, Al₂O₃ and porous glass. Examples of porous organic supports are network organic polymers (e.g. based on polymethacrylates, polyacrylates, poly-styrene, biopolymers such as agarose or dextrane). The flat surfaces can be silicon (oxidised or nonoxidised), glass, MICA, gold or modified gold surfaces).

Organic or inorganic components can be used as the template. There are preferably used as templates: ions, antibodies, antigens, amino acids, peptides, proteins, DNA bases, carbohydrates, drugs, pesticides, nucleic acids, viruses, bacteria or cells.

In addition, the invention relates to the molecularly imprinted polymer material produced by the process according to the invention which comprises one or more molecularly imprinted or non-imprinted polymer films. The latter can consist of identical and/or different monomers.

It is possible to polymerise hydrophilic polymer layers onto a molecularly imprinted layer. The material obtained in this way can be used for the suppression of non-specific binding in aqueous systems.

The molecularly imprinted polymer materials produced by the method according to the invention can be used in substance-specific material separation for the concentration, purification, separation or analytical determination of substances in chromatography, in catalysis or in biosensor technology.

It is in addition possible to use the method according to the invention for the continuous production of MIPs. For example, column reactors can be used, which are fitted with thermostats that are heated for the initiation of the polymerisation. The reactors can also be equipped with a window permeable to UV light, in order likewise to initiate the polymerisation. Initiator-modified particles are passed through the column reactor; on their downward passage they are induced to undergo polymerisation by means of UV light or temperature. The residence time of the particles at the initiation site of the column thus determines the thickness of the polymer film.

The method according to the invention will be explained in detail below from examples:

For the production of the MIP film, first of all a porous support, preferably silica gel particles are modified with azo initiators. Traditional methods from the prior art are used for this, for example the method according to Revillon by the coupling of 4,4′-azobis(4-cyanopentanoic acid) (ACPA) with silica gel, modified with (3-aminopropyl)triethoxysilane (Si-APS), or with glycidoxypropyl-trimethoxysilane (Si-GPS).

While the invention has been described in relation to certain disclosed embodiments, the skilled person may foresee other embodiments, variations, or combinations which are not specifically mentioned but are nonetheless within the scope of the appended claims.

All references cited herein are hereby incorporated by reference in their entirety.

The invention will now be described by way of the following non-limiting examples.

### EXAMPLE 1

### MIP Material According to the Method of the Invention

The following are required to produce the MIP composite material:

| | | |
|---|---|---|
| 80 | mg | Azo initiator (i.e. AIBN). |
| 0.24 | g | LPA: L-phenyl alanine anilide (template) |
| 0.2 | g | RAFT agent: 2-phenylprop-2-yl-dithiobenzoate |
| 0.68 | ml | MAA: methacrylic acid (functional monomer) |
| 7.6 | ml | EDMA: ethylene glycol bismethacrylate (crosslink monomer) |
| 11.2 | ml | toluene |

A prepolymerization mixture is prepared consisting of LPA, RAFT agent and EDMA, dissolved in toluene. The polymerisation is then initiated by means of UV light, or thermally at elevated temperatures.

During this period the mixture is purged with nitrogen. After the polymerisation the MIP material is crushed and the particles washed with methanol by means of Soxhlet extraction and then dried.

### EXAMPLE 2

### MIP Composite Material According to the Method According to the Invention

The following are required to produce the MIP composite material:

| | | |
|---|---|---|
| 1 | g | Azo-modified silica gel particles |
| 0.24 | g | LPA: L-phenyl alanine anilide (template) |
| 0.2 | g | RAFT agent: 2-phenylprop-2-yl-dithiobenzoate |
| 0.68 | ml | MAA: methacrylic acid (functional monomer) |
| 7.6 | ml | EDMA: ethylene glycol bismethacrylate (crosslink monomer) |
| 11.2 | ml | toluene |

Silica gel particles are first of all suspended in a polymerisation mixture of LPA, RAFT agent and EDMA, the mixture being dissolved in toluene. The polymerisation is then initiated by means of UV light, or thermally at elevated temperature according to the reaction equation:

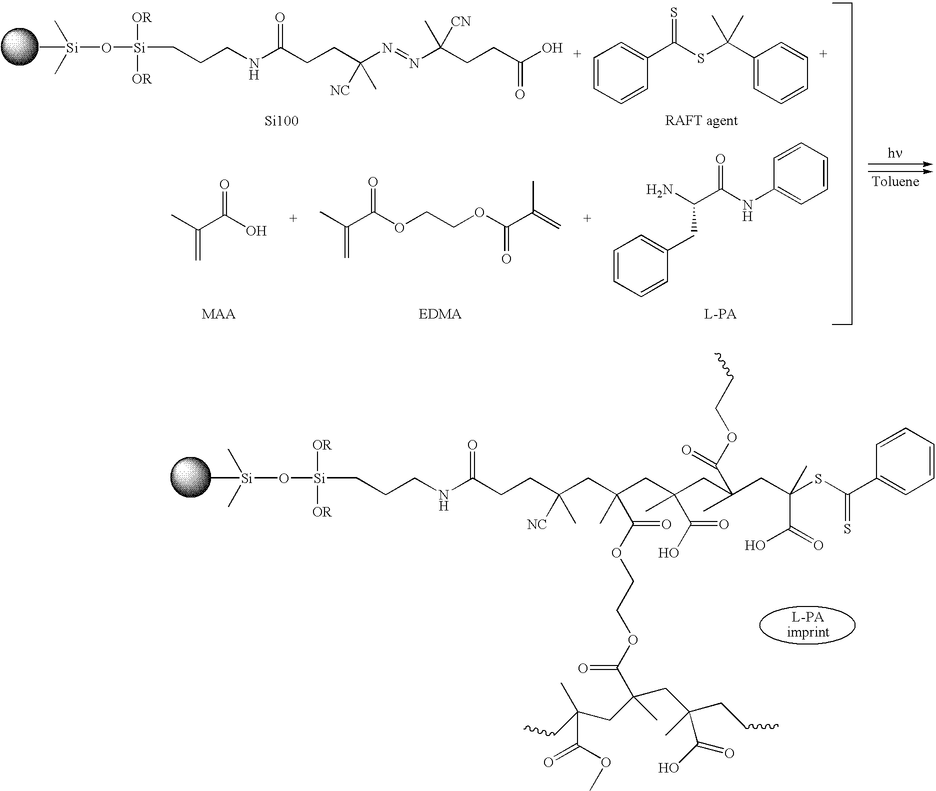

During this period the mixture is purged with nitrogen. After the polymerisation the MIP composite material is washed with methanol by means of Soxhlet extraction and then dried.

### EXAMPLE 3

### MIP Composite Material According to the Method According to the Invention

| | | |
|---|---|---|
| 1 | g | Azo-modified silica gel particles |
| 0.24 | g | L-PA: L- phenyl alanine anilide (template) |
| 0.2 | g | RAFT agent: 2-phenylprop-2-yl-dithiobenzoate |
| 0.68 | ml | MAA: methacrylic acid (functional monomer) |
| 5.3 | ml | EDMA: ethylene glycol bismethacrylate (crosslink monomer) |
| 2.0 | ml | HEMA: 2-hydroxyethyl methacrylate |
| 12 | ml | 1,1,1-trichlorethane |

The polymerisation is likewise initiated according to Example 1.

### EXAMPLE 4

### Coating of the MIP Composite Material for the Separation of Enantiomers in Aqueous Media

The MIP composite material from Example 1 or 2 is suspended in a polymerisation mixture of

| | |
|---|---|
| 5.0 ml | HEMA: 2-hydroxyethyl methacrylate |
| 10.0 ml | methanol |

and as free radical initiator AIBN (azo-N,N′-bis-isobutyronitrile). After the polymerisation the particles are obtained by means of Soxhlet extraction and dried. An MIP composite material with an inner L-PA-selective film and an outer hydrophilic film is obtained.

1-17. (canceled)

18. Method for producing molecularly imprinted polymers (MIP) in which at least one functional monomer, one template and one initiator is used for the polymerisation, characterised in that RAFT agents are used.

19. Method according to claim 18, characterised in that the RAFT agent is a dithioester of the general structure. 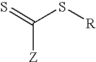
where R is a homolytic group which initiates the polymerisation and Z is a group which allows the thiocarbonyl group to react with radicals.

20. Method according to claim 19, the dithioester is chosen from the following group: 11-phenylprop-2-yl phenyldithioacetate; 1-phenylethyl phenyldithioacetate, cumyl phenylditioacetate, 2-phenylprop-2-yl dithiobenzoate; 1-phenylprop-2-yl p-bromodithiobenzoate; 1-phenylethyl dithiobenzoate; 2-cyanoprop-2-yl dithiobenzoate; 4-cyanopentanoic acid dithiobenzoate; 1-acetoxyethyl dithiobenzoate; hexakis(thiobenzoylthiomethyl)benzene; 1,4-bis(thiobenzoylthiomethyl)benzene; 1,2,4,5-tetrakis(thiobenzoylthiomethyl)benzene; ethoxycarbonylmethyl dithioacetate; 2-(ethoxycarbonyl)prop-2-yl dithiobenzoate; tert-butyl dithiobenzoate; 1,4-bis(2-thiobenzoylthioprop-2-yl)benzene; 4-cyano-4-(thiobenzoylthio)pentanoic acid; dibenzyl trithiocarbonate; carboxymethyl dithiobenzoate; s-benzyl diethoxyphosphinyldothioformate; 2,4,4-trimethylpent-2-yl dithiobenzoate; 2-(ethoxycarbonyl)prop-2-yl dithiobenzoate; 2-phenylprop-2-yl1-dithionaphthalate; 2-phenylprop-2-yl4-chlorodithiobenzoate.

21. Method according to claim 18, characterised in that the initiation takes place by means of UV irradiation and/or thermally at elevated temperature.

22. Method according to claim 18 in which the polymerization is performed by grafting from the surface of a support material leading to a thin polymer film.

23. Method according to claim 22, characterised in that the support material consists of porous or non-porous, planar or non-planar, inorganic or organic material.

24. Method according to claim 22, characterised in that preferably the support material consists of porous silica gel particle.

25. Method according to claim 18, characterised in that the template consists of organic or inorganic components.

26. Method according to claim 18, characterised in that there are used as templates: ions, antibodies, antigens, amino acids, peptides, proteins, DNA bases, carbohydrates, drugs, pesticides, nucleic acids, viruses, bacteria or cells.

27. Method according to claim 18, characterised in that azo-based initiators, iniferters, preferably benzyl-N,N-diethyl-dithiocarbamate are used as initiator.

28. Method according to claim 18, characterised in that immobilised initiators are used.

29. Molecular imprinted polymer material according to claim 18.

30. Molecular imprinted polymer material according to claim 29, characterised in that it consists of one or more molecular imprinted polymer films.

31. Molecular imprinted polymer material according to claim 29, characterised in that the molecular imprinted polymer films consist of identical and/or different monomers.

32. Use of molecularly imprinted polymers (MIP), produced by a method in which at least one functional monomer, one template and one initiator is used for the polymerisation, for the separation and enrichment of molecules, for use in chromatography, and for use in catalysis or in sensor technology.

33. Use according to claim 32, wherein the RAFT agent is a dithioester of the general structure. 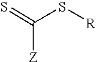
where R is a homolytic group which initiates the polymerisation and Z is a group which allows the thiocarbonyl group to react with radical.

34. Use of the method according to claim 18 for the continuous production of MIP.

35. Use of the RAFT technique to produce molecular imprinted polymers (MIP) which are applied as a thin film to the surface of a support material, in which at least one functional monomer, one template and one initiator is used for the polymerisation.
